(19) United States
(12) Patent Application Publication
(10) Pub. No.: US 2024/0136648 A1
(43) Pub. Date: Apr. 25, 2024

(54) PRESSURE RELIEF DEVICE, AND BATTERY HOUSING COMPRISING SUCH A PRESSURE RELIEF DEVICE

(71) Applicant: HUGO BENZING GMBH & CO. KG, Korntal-Münchingen (DE)

(72) Inventor: Udo SCHOLPP, Stuttgart (DE)

(21) Appl. No.: 17/768,850

(22) PCT Filed: Dec. 9, 2020
(86) PCT No.: PCT/EP2020/085302

§ 371 Date: Apr. 12, 2022

(51) Int. Cl. H01M 50/333; H01M 50/375

(52) U.S. Cl. CPC H01M 50/333; H01M 50/375; H01M 2200/10; H01M 2200/20

(57) ABSTRACT

The invention relates to a pressure relief device for carrying out a pressure relief function for a cell-like cavity (5) which is enclosed by a battery housing (1), comprising a pressure relief cover unit (2) that is or can be inserted into a housing wall (10) and opens a flow path (13) from the cavity into an outer region (4) of the housing (1) when in particular a pressure threshold and/or temperature threshold is exceeded. Reliable functioning is supported by the pressure relief cover unit (2) being directly or indirectly connected to a sensor device (6) which comprises at least one sensor element (60) and is or can be involved in particular in a pressure relief monitoring process and/or in the pressure relief function.

The invention relates to a pressure relief device for carrying out a pressure relief function for a cell-like cavity which is enclosed by a battery housing, comprising a pressure relief cover unit that is or can be inserted into a housing wall and opens a flow path from the cavity into an outer region of the housing when in particular a pressure threshold and/or temperature threshold is exceeded. The invention also relates to a battery housing comprising at least one such pressure relief device.

The present invention relates to cover-like pressure relief devices for housings which bring about pressure equalization even in the case of relatively low pressure differences between the housing interior and the external environment (usually atmosphere) of e.g. less than a few bar, usually less than 500 mbar, as is typical for use in battery or accumulator housings. This is a significant difference compared to e.g. control valves or safety valves in piping systems, which are not the subject of the present application.

A pressure relief device of this type is disclosed as known in DE 10 2016 121 605 A1. In this known pressure relief device, a pressure relief cover unit is present which can be inserted into a housing wall of a housing which encloses a cell-like cavity, such as a battery cell. If the pressure in the cavity exceeds a pressure threshold, the pressure relief cover unit opens a flow path from the cavity within the housing into the outer region of the housing, which prevents a harmful internal pressure in the cavity. The pressure relief cover unit has a spring clip with a plurality of spring tongues which are directed radially outward and engage the housing wall from below, and a cover part which lies tightly on the outside of the housing wall around the edge of the opening and which remains pressed against the housing wall by means of the spring clip, so as to close the opening, when the pressure does not meet a predetermined pressure threshold, but which, when the pressure threshold is exceeded, is lifted against the spring force by the pressure in the cavity in order to open the flow path from the cavity to the outside. In order to reliably prevent damage, e.g. in the event of excessive pressure and/or excessive heat generation and the associated exceeding of the pressure threshold, reliable functioning must be ensured under as many occurring operating conditions as possible, in particular in connection with a battery housing.

Further pressure relief devices comprising a pressure relief cover unit are disclosed in DE 10 2011 109 310 A1, DE 10 2016 004 648 A1 and DE 10 2015 005 276 A1, the latter having pressure relief cover units that comprise a cover part which is provided with a breakaway edge and is connected to the housing via a strip-like hinge.

DE 10 2017 123 078 A1 discloses a pressure relief device in the form of a pressure equalization unit having a membrane which is protected inside a pressure relief cover unit and through which a flow path for gases is formed from the cavity into the outer region of the housing, in particular the battery housing.

The problem addressed by the present invention is that of providing a pressure relief device for a battery housing in a design which enhances the functionality and provides reliable operation, and that of providing a battery housing comprising such a pressure relief device.

This problem is solved by a pressure relief device having the features of claim 1 and a battery housing comprising such a pressure relief device according to claim 12. In this case, the pressure relief cover unit is directly or indirectly connected to a sensor device which comprises at least one sensor element and is or can be involved in particular in a pressure relief or temperature monitoring process and/or in the pressure relief function.

With these measures, on the one hand, the reliable functioning of the pressure relief can be monitored and the reliable functionality can be restored or supported e.g. automatically or through early maintenance and/or, by means of sensor signals emitted by the at least one sensor element, control signals can be generated e.g. for an acoustic or optical display or for reducing a risk potential in the environment, e.g. by switching off or throttling the operation of adjacent units. The sensor device, in particular the sensor element, is advantageously integrated into the pressure relief cover unit and therefore is or can be directly aligned with the function of the pressure relief device or the battery housing. The sensor signals or control signals obtained therefrom can e.g. be used for operational open- or closed-loop control, for example via an appropriately designed actuator system. The structure in the design with a pressure relief cover unit results in a relatively flat structure which contributes to convenient installation in the opening in the housing wall. The lateral extent (parallel to the container wall) is usually much greater than (e.g. more than double or triple) the thickness or height (perpendicular to the container wall). This design also favors a response at the relatively low container pressures inside battery housings (usually less than 500 mbar), as occur in traction batteries (high-voltage batteries, 48 V) for electric vehicles or hybrid vehicles and electrical-system batteries. The pressure relief cover unit is advantageously adapted or adaptable to various physical conditions, for example for a speedy response to typical pressure relief speeds by opening large flow cross sections favored by the flat design and/or taking into account the relation of housing volume to flow cross section. If necessary, a plurality of such closure units can be provided in the form of the pressure relief cover unit in a battery housing. When an overpressure is reduced, different flow conditions can occur in the region of the container openings, e.g. depending on the origin of the overpressure and the geometry of built-in elements. Reliable functioning is supported with the aid of the sensor device.

An advantageous embodiment for ensuring the pressure relief function is one in which the sensor device is involved in the actuation of the pressure relief cover unit. For example, a cover part can be lifted against a spring force and/or a sealing film can be torn by means of an actuating element in order to bring about the pressure relief in a metered manner or else abruptly.

If the sensor device is designed to transmit sensor signals to a reporting system, then e.g. an opening of the pressure relief cover unit or a previously building pressure can possibly also be signaled or displayed in connection with other signals, e.g. via an acoustic or optical display, and/or used in connection with other information for the open- or closed-loop control of other units as well. In this way, for example, possible damage can be prevented or reduced at an early stage.

A further embodiment that is advantageous for targeted open- or closed-loop control or for appropriate monitoring measures is one in which the sensor device is provided with a processing unit for the sensor signals.

Targeted pressure relief measures can advantageously also be carried out in that the sensor device is or can be involved in the pressure relief function for an open- or closed loop control intervention.

Various advantageous design variants for influencing or monitoring the pressure relief function are obtained in that the sensor device is alternatively or cumulatively designed with at least one of the functions of pressure detection, temperature detection, position detection, displacement detection, speed detection and acceleration detection.

Various advantageous design variants for the detection and action in connection with the pressure relief function consist in the sensor device having at least one sensor element from the group of strain sensors, piezoelectric sensors, thermoelectric sensors, electromagnetic sensors, capacitively measuring sensors, bimetallic elements and shape memory elements alone or in a combination of at least two sensor elements. A sensor element can also be formed by a thin tear wire or an arrangement of multiple tear wires. Such a tear wire can for example be designed in such a way that it tears even at a low pressure that exceeds a predetermined pressure threshold, whereby it is attached to or integrated into e.g. an element that expands when the housing is under pressure. Its untorn, intact state can be monitored e.g. by monitoring a low current flow.

An advantageous embodiment for targeted pressure relief measures is one in which the pressure relief device comprises at least one actuator. The actuator is advantageously integrated directly into the pressure relief cover unit.

For the functioning of the pressure relief device, the actuator advantageously causes the pressure relief cover unit to open and/or close directly or indirectly on the basis of a sensor signal from at least one sensor element. The actuator can comprise e.g. a final control element that can be controlled in an open or closed loop for opening or closing the flow path through the pressure relief cover unit.

An embodiment which is further advantageous for the structure and functioning results from the fact that the at least one sensor element and the at least one actuator are integrated into a common component of the pressure relief cover unit. For example, a spring element of the pressure relief cover unit equipped with finger-like, radially outwardly extending spring tongues can be provided with bimetallic elements which, in addition to responding to pressure as a result of the spring forces of the elastic spring tongues, can also respond to heat generation in the cavity, such as a battery cell, and lift a cover part of the pressure relief cover unit in order to open the flow path. A redundant safety function of the pressure relief device can be formed in this way, for example.

The invention in particular also comprises battery housings comprising at least one pressure relief device according to claims 1 to 11. Battery housings can also be understood as meaning accumulator housings, with vehicle batteries and accumulators being considered in particular.

The invention will be explained in more detail below on the basis of embodiments and with reference to the drawings, in which:

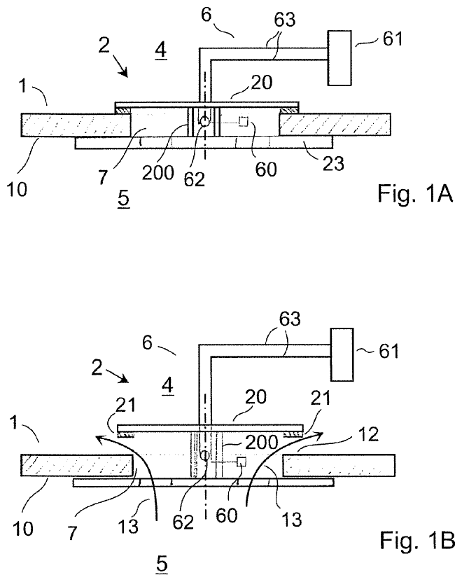

FIG. 1A is a schematic cross section of a pressure relief device with a pressure relief cover unit inserted into an opening in a housing and a sensor device in a closed state,

FIG. 1B shows the pressure relief device according to FIG. 1A in the open state,

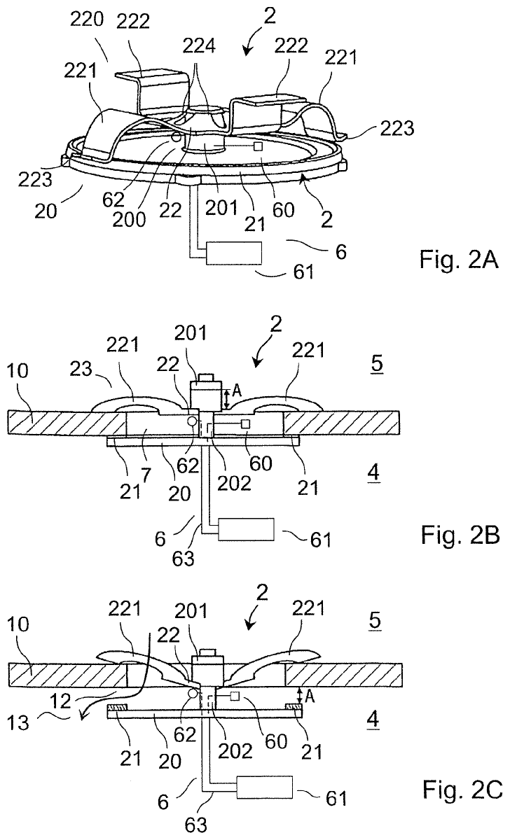

FIG. 2A is a perspective view from below of a further embodiment of a pressure relief device with a (reversed) pressure relief cover unit and a sensor device connected thereto,

FIG. 2B is a schematic side view of the pressure relief device according to FIG. 2A in a state inserted into a housing opening in the closed state and with a sensor device,

FIG. 2C shows the pressure relief device according to FIGS. 2A and 2B in the open state of the pressure relief cover unit,

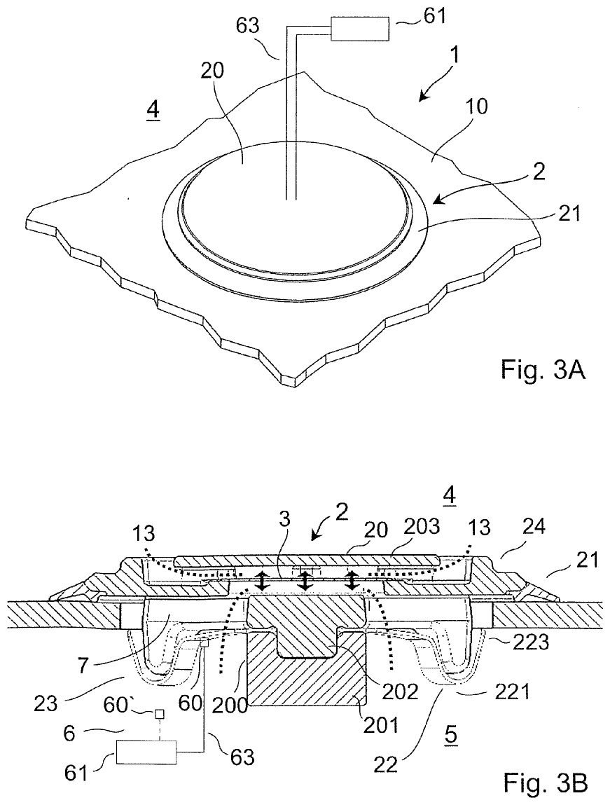

FIG. 3A is a perspective view from above of a further embodiment of a pressure relief device with a pressure relief cover unit inserted into a housing opening and with a sensor device,

FIG. 3B is a sectional side view of a pressure relief device according to FIG. 3A with a pressure relief cover unit inserted into a housing opening and a sensor device,

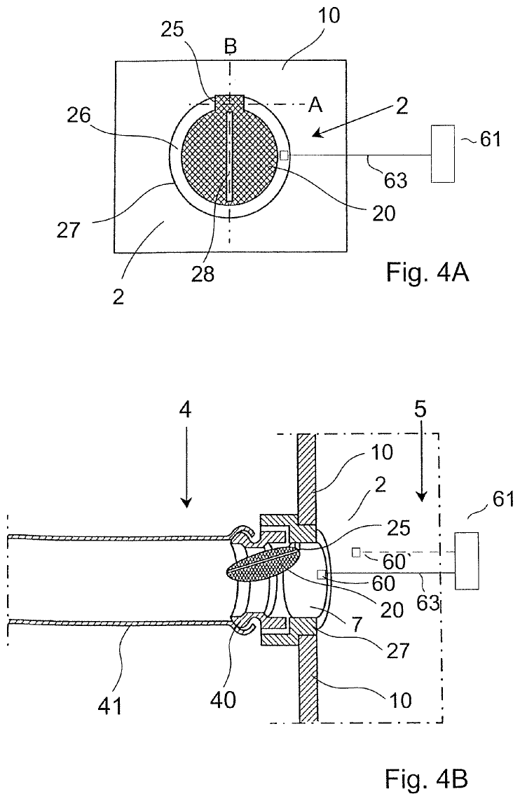

FIG. 4A is a top view of a further embodiment of a pressure relief device with a pressure relief cover unit inserted into a housing opening and a sensor device and

FIG. 4B is a partially sectioned perspective view from the side of the pressure relief device according to FIG. 4A.

FIG. 1A shows a pressure relief device comprising a pressure relief cover unit 2, which is inserted into an opening 7 present in a housing wall 10 of a battery housing 1, in the closed state and also shows a sensor device 6 connected to the pressure relief cover unit 2. FIG. 1B shows the pressure relief device according to FIG. 1A in the open state, in which a cover part 20 is lifted from the outer side of the housing wall 10 so that a flow path 13 from a cavity 5 enclosed by the battery housing 1 into the outer region 4 of the battery housing 1 is opened and, in the case of excess pressure in the cavity 5, an in particular gaseous medium which is present can flow into the outer region 4. In the closed state, the cover part 20 lies sealed on the outer side of the housing wall 10 by means of a seal around the edge of the opening 7. Such pressure relief devices for battery housings 1 form a relatively large flow cross section even when a cover part is slightly deflected to relieve the pressure or when it is torn open, so that rapid pressure equalization can take place even when the overpressure (usually between the housing interior and the surrounding exterior or atmosphere) exceeds a relatively low pressure threshold, e.g. in the range of up to 500 mbar.

The sensor device 6 has a sensor element 60, in this case arranged on the pressure relief cover part 2, and in this case also an actuator 62, which are connected for example to a processing unit 61 via connection means 63 in order to process or evaluate sensor signals emitted by the sensor element 60 and e.g. to additionally use them for actuating a signaling system (not shown) and/or for actuating the actuator 62. The processing unit 61 is schematically shown here as a unit arranged outside the pressure relief cover unit, but can advantageously also be built into the pressure relief cover unit 2, so that the pressure relief device forms a compact unit with the pressure relief cover unit 2 and the sensor device 6. For external use, the processing unit 61 can be provided with an interface for wireless or wired data transmission in order to use status data provided by the sensor device 6 via the processing unit 61 e.g. for an acoustic or optical display via a display device and/or for the control of further units, as mentioned at the outset.

The actuator 62 can comprise e.g. a final control element by means of which the cover part 20 can be lifted from the outer side or a circumferential sealing surface 12 around the opening 7 for opening, or placed thereon for closing. Such a final control element can be arranged e.g. in a portion of a central holding part 200 of the pressure relief cover unit 2 by means of which the cover part 20 is held on a lower part 23 connected to the housing wall 10 or brought into contact with it. As shown in FIGS. 1A and 1B, passage openings or recesses are arranged in the lower part 23 to form the flow path 13 from the housing interior or cavity 5 into the outer region 4.

FIGS. 2A, 2B and 2C show a second embodiment of a pressure relief device. In this case, the pressure relief cover unit 2 also has a cover part 20 which, in the closed state, abuts the outer side of the housing wall 10 in the region of the sealing surface 12 via a seal 21 around the opening 7. In this case, the lower part 23 of the pressure relief cover unit 2 has a spring clip 22 which is provided with spring tongues 220 which are directed radially outward and comprise long spring portions 221 and short spring portions 222. The long spring portions 221 form elastically resilient spring tongues which are supported on the inner side of the housing wall 10 around the edge of the opening 7 and are elastically deflected when the medium or gas pressure in the interior or cavity 5 of the battery housing 1 exceeds a certain pressure threshold, so that the cover part 20 is lifted from the outer side of the housing wall 10 and the flow path 13 through the opening 7 is opened. The short spring portions 222 limit the opening displacement by their end portions striking the underside of the housing wall 10 when the cover part 20 is lifted by a maximum opening displacement A. If the pressure in the cavity 5 falls below the pressure threshold (in particular in a range below 500 mbar), the spring force of the long spring portions 221 causes the cover part 20 to be pressed again against the sealing surface 12 on the outer side of the housing wall 10 and sealed by means of the seal 21. Here, too, the sensor device 6 has a sensor element 60 which is arranged inside the pressure relief cover unit 2 and is connected to a processing unit 61. Furthermore, an actuator 62 can be connected to the processing unit 61 for actuating, e.g. opening and/or closing, the cover part 20 or for supporting these operations. For example, the sensor element 60 can respond to the internal pressure in the interior or cavity 5 of the battery housing 1 and transmit pressure-dependent sensor signals to the processing unit 61 for processing or evaluating and providing status or control data. As in the first embodiment, these can in turn be used for pressure relief monitoring and/or for influencing the pressure relief function. Alternatively or additionally, the or a further sensor element 60 can be designed e.g. as a temperature sensor, so that the opening of the pressure relief cover unit 2 or a lifting of the cover part 20 can also be controlled in an open or closed loop depending on the temperature. In this way, an additional, redundant actuation of the pressure relief cover unit 2 can be provided and/or an additional monitoring function can be formed. In this embodiment, too, all sensor elements and possibly actuator elements and possibly also the processing unit 61 can advantageously be integrated into the pressure relief cover unit 2 in order to form a compact structural unit.

In the second embodiment, too, the cover part 20 is connected to the lower part 23 or the spring clip 22 thereof by means of a holding part 200, the holding part 200 being provided with a holding portion 201 and an intermediate piece 202. The processing unit 61 can also be integrated into the pressure relief cover unit 2, as in the first embodiment. Furthermore, at least one sensor element 60 can be arranged on the spring clip 22 in order to detect the bending, strain or compression thereof. The sensor element or elements 60 can e.g. be designed as strain gauges. An alternative or additional design of one or more sensor elements 60 can e.g. consist of a bimetallic element which responds to a change in temperature by changing the movement in such a way that the cover part 20 is lifted when a certain temperature is exceeded and closed when the temperature drops below a certain temperature threshold. Other sensor elements, as mentioned at the outset, are also possible.

In the third embodiment shown in FIGS. 3A and 3B, the pressure relief device also has a pressure relief cover unit 2 and a sensor device 6 connected thereto. The pressure relief cover unit 2 in turn has a cover part 20 and a lower part 23 which is provided with a spring clip 22 and is connected to the cover part 20 via a holding part 200. Here, too, the spring clip 22, as in the second embodiment, is provided with radially outwardly projecting spring tongues 220 which comprise long spring portions 221 and (not shown) short spring portions. The long spring portions 221 are supported with end portions 223 on the underside of the housing wall 10 around the edge of the opening 7 and are elastically deflected to lift the cover part 20 when the pressure in the cavity 5 exceeds a certain pressure threshold (which is preferably not higher than 500 mbar).

A membrane 3 covered on the outer side by a cover wall 203 is inserted in the cover part 20 in order to keep particles or foreign bodies away from the cavity 5 and to allow the gas pressure between the cavity 5 and the outer region 4 to be equalized via the flow path 13. In this case, one or more sensor elements 60, 60′ are arranged on or near the pressure relief cover unit 2 (or integrated into the pressure relief cover unit 2), with different design variants of the sensor elements 60, 60′ being possible, as stated at the outset. The membrane 3 can be designed e.g. as a sensor element 60 itself or have one or more sensor elements 60. The sensor elements of the membrane 3 can be designed e.g. as a tear wire and/or can advantageously comprise strain-sensitive threads or strips, such as elastomer strips, which change their electrical resistance or capacitance when stretched, so that AC signals are generated or changed depending on the stretching or bulging of the membrane 3 and can be passed on and processed as sensor signals. The pressure relief cover unit 2 can thus fulfill additional sensor functions in order to bring about or support the pressure relief monitoring and/or pressure relief function.

This sensor device 6 or the pressure relief cover unit 2 can thus also be integrated into a reporting system or open- or closed-loop control system in order to fulfill the pressure relief monitoring and/or pressure relief function. In particular when integrating the sensor device 6 and possibly also the processing unit 61 and/or actuators 62 into the pressure relief cover unit 2, the entire pressure relief device can also be designed as a compact unit in this embodiment as well as in the previous embodiments.

In the fourth embodiment shown in FIGS. 4A and 4B, the pressure relief device has a pressure relief cover unit 2 and a sensor device 6 connected thereto, which can be designed in accordance with the above embodiments. The pressure relief cover unit 2 has a cover part 20 which is connected in a media-tight manner to a separating edge 27 of the housing wall 10 via a separable separating region 26 and is also fastened to the housing wall 10 by means of at least one hinge-like connection 25 or strip. If the internal pressure in the cavity 5 exceeds the pressure threshold, the separating region 26 opposite the separating edge 27 tears off and is destroyed, and the flow path 13 from the cavity into the outer region 4 is opened as a result, with the cover part 20 being held against the housing wall 10 via the connection 25. To prevent the escaping medium or gas from the cavity 5 from escaping directly into the environment, a pipe 41 for diverting the escaping medium is connected to the opening 7 via a connecting part 40. In this case, a sensor element 60, such as a tear wire, can be designed e.g. to detect the tearing off of the separating region 26 by e.g. a current flow that is detected by the processing unit 61 being stopped. Further sensor elements 60 may also be present in order to report corresponding states and to use them e.g. for open- or closed-loop control similarly to the previous embodiments.

1. A Pressure relief device for carrying out a pressure relief function for a cell-like cavity (5) which is enclosed by a battery housing (1), comprising a pressure relief cover unit (2) that is or can be inserted into a housing wall (10) and opens a flow path (13) from the cavity into an outer region (4) of the housing (1) when in particular a pressure threshold and/or temperature threshold is exceeded,
characterized in that
the pressure relief cover unit (2) is directly or indirectly connected to a sensor device (6) which comprises at least one sensor element (60) and is or can be involved in particular in a pressure relief monitoring process and/or in the pressure relief function.

2. The Pressure relief device according to claim 1,
characterized in that
the sensor device (6) is involved in the actuation of the pressure relief cover unit (2).

3. The Pressure relief device according to claim 1,
characterized in that
the sensor device (6) as a whole or at least one sensor element (60) is structurally integrated into the pressure relief cover unit (2).

4. The Pressure relief device according to claim 1,
characterized in that
the sensor device (6) is designed to transmit sensor signals to a reporting system.

5. The Pressure relief device according to claim 1,
characterized in that
the sensor device (6) is provided with a processing unit (61) for sensor signals.

6. The Pressure relief device according to claim 1,
characterized in that
the sensor device (6) is or can be involved in the pressure relief function for an open- or closed-loop control intervention.

7. The Pressure relief device according to claim 1,
characterized in that
the sensor device (6) is designed with at least one of the functions of pressure detection, temperature detection, position detection, displacement detection, speed detection, acceleration detection, flow detection and detection of chemical substance changes.

8. The Pressure relief device according to claim 6,
characterized in that
the sensor device (6) has at least one sensor element (60) from the group of strain sensors, piezoelectric sensors, thermoelectric sensors, electromagnetic sensors, capacitively measuring sensors, bimetallic elements and shape memory elements alone or in a combination of at least two sensor elements (60, 60′).

9. The Pressure relief device according to claim 1,
characterized in that
it comprises at least one actuator (62) and in that the actuator (62) is assigned to the pressure relief cover unit (2), in particular integrated into it.

10. The Pressure relief device according to claim 9,
characterized in that
the actuator (62) causes the pressure relief cover unit (2) to open and/or close directly or indirectly on the basis of a sensor signal from at least one sensor element (60).

11. The Pressure relief device according to claim 10,
characterized in that
the at least one sensor element (60) and the at least one actuator (62) are integrated into a common component of the pressure relief cover unit (2).

12. A Battery housing comprising at least one pressure relief device according to claim 1.
